(19) United States
(12) Patent Application Publication
(10) Pub. No.: US 2006/0178077 A1
(43) Pub. Date: Aug. 10, 2006

(54) Lamp

(75) Inventor: Arnd Ritz, Heinsberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N. V., Eindhoven (NL)

(21) Appl. No.: 10/549,645

(22) PCT Filed: Mar. 19, 2004
(86) PCT No.: PCT/IB04/50292

§ 371 Date: Sep. 20, 2005

(30) Foreign Application Priority Data
Mar. 24, 2003 (EP) 03100742.0

(51) Int. Cl. H01J 9/20; H01J 9/00; H01J 9/22

(52) U.S. Cl. 445/58

(57) ABSTRACT

The invention relates to a lamp comprising a lamp bulb (1), on the surface of which at least one interference filter (3) is at least partially located, wherein at least this interference filter (3) comprises several layers, wherein the layer structure comprises alternating layers (3.1) with a higher refractive index and layers (3.2) with a lower refractive index, wherein at least the outer layer and/or at least one inner layer of the interference filter (3) comprises a protective layer (4) to reduce thermal and/or intrinsic stresses, and wherein the thickness of the protective layer (4) or protective layers (4) has a value below 40% of the value of all other layers with the lower refractive index.

The invention relates to a lamp comprising at least a lamp bulb on the surface of which an interference filter is at least partially located, wherein at least said interference filter comprises several layers, wherein the layer structure comprises alternating layers with a higher and layers with a lower refractive index, and wherein said interference filter comprises at least one protective layer to reduce thermal and/or intrinsic stresses.

High intensity discharge (HID) lamps and, more particularly, ultra high performance (UHP) lamps are preferred for projection purposes, amongst other things because of their optical properties. In the sense of the invention, the designation UHP lamp (Philips) also includes UHP type lamps from other manufacturers.

In this application, a light source that is as punctiform as possible is required so that the light arc that is formed between the electrode tips does not exceed a specific length. In addition, the highest possible luminous intensity with the most natural possible spectral composition of the light is required.

The integration of optical layers, for example of interference filters, on lamp bulbs of high intensity discharge lamps can significantly simplify the design of optical equipment.

One such example is the integrated reflector on a UHP lamp which can be used as the light source in a data beamer. Here, one half of the lamp bulb is fitted with a mirror that is designed as an interference filter so that the light emitted by the light arc is preferentially sent to the other half of the lamp bulb. The result is that the emitted light can be more efficiently used for the projection system.

Such interference filters are regularly structured with several layers. In a multi-layer structure of the interference filter, layers alternate between layers with a higher and layers with a lower refractive index. The refractive index of each layer is determined mainly by the selected layer material, such that at least two different dielectric materials in this respect must be used in the layer structure.

The transmission and reflection properties of the filter are determined by the design of the different layers of the filter, more particularly the layer thicknesses.

In general, a desired spectral target function can be more easily realized as the difference between the refractive indices of the different filter layers is greater. With a large difference between the values of the refractive indices of the layer materials, the number of alternating layers and therefore frequently the overall thickness of the interference filter can in general be reduced. If the lamp bulb more particularly comprises quartz or an equivalent material, SiO₂ is frequently used as the material for the layer with the lower refractive index. The selection of the material for the layer with the higher refractive index must take into account the range of normal operating temperatures for UHP lamps, the upper range of which lies around 1000° C. Sufficient temperature resistance in this regard is demonstrated for instance by zirconium oxide (ZrO₂). However, zirconium oxide has a significantly higher thermal expansion coefficient than quartz. This can result in the development of stresses between the layers of the interference filter at the high operating temperatures of HID lamps, more particularly UHP lamps, which may cause crack formation up to the point of complete destruction of the filter, or may produce an unwanted increased light scattering.

If HID lamps, more particularly UHP lamps, are used, two important requirements must be met simultaneously:

On the one hand, the highest temperature on the inner surface of the discharge space must not be so high that devitrification of the lamp bulb, which generally consists of quartz glass, occurs. This can be problematic because the area above the light arc is particularly strongly heated by the strong convection within the discharge space of the lamp.

On the other hand, the coldest point on the inner surface of the discharge space must still have such a high temperature that the mercury is not deposited there, but remains overall at a sufficient level of vaporization. This must be particularly taken into account for lamps with saturated gas fillings.

These contradictory requirements imply that the maximum permissible difference between the highest and lowest temperatures is relatively small. When operating one of these HID lamps at the loading limit of the construction materials, any change in the temperature field, e.g. an increase in temperature, can have negative effects on the performance parameters, such as service life.

This optimized system reacts very sensitively to measures that influence or change the temperature field in the discharge space. The application of a reflective layer on the outer surface is one such measure whereby the operating temperature of the UHP lamp, compared with a similar lamp without a coating, normally rises. This is because, amongst other reasons, a multiple reflection inside the lamp usually causes increased re-absorption. A coating, for example a multi-layer interference filter, usually causes a reduction in heat radiation at the lamp surface compared with the pure quartz surface of an uncoated surface, so that the lamp gives off less heat and therefore the operating temperature rises accordingly.

In order to reduce the change in the temperature field to a minimum when using multi-layer interference filters, the thickness of the interference filter, including a protective layer, must be kept as small as possible.

If a UHP lamp is installed in a projection system, for instance, the design of the multi-layer interference filter must regularly meet particular requirements, where the minimum possible thickness of the protective layer, which can be variably positioned, could result in new possibilities with regard to design.

Halogen lamps are also coated with optical interference filters for special applications, more particularly to increase their efficiency. Here, the infrared portions of the radiated spectrum, which cannot be used for illumination purposes in other ways, are reflected back to the incandescent filament and reabsorbed. This reabsorbed capacity contributes to the heating of the incandescent filament and therefore enables a reduction in the electrical power required for this purpose. High-refraction layers in this case often use materials from the group of titanium oxide, tantalum oxide, niobium oxide, or mixtures thereof. As such applications require a good transmission in the visible spectrum in addition to the wide reflection band in the infrared, complicated filters are often used with high layer numbers and great total thickness, for example more than 60 layers and a total thickness over 6 μm. These materials also come close to the stability limits at the usual operating temperatures of halogen lamps, even though their thermal expansion coefficient difference with the lamp bulb material (substrate) is less than, for example, with ZrO₂. This means that there is a demand for extended design options regarding multi-layer interference filters with stress-reducing layers in thicker and more efficient filter coatings.

A basic solution is known from U.S. Pat. No. 5,923,471 for various application cases of lamps and displays in that an external protective layer is applied on the actual optically effective multi-layer interference filter. This proposes, amongst other things, that the thickness of the protective layer must not drop below a specific thickness in the operating temperature range between room temperature and a temperature of circa 1200° C. to achieve the required success. A value is given for the minimum thickness of the protective layer, which must not undershoot at least 50% of the value of all other silicate layers in the interference filter. This necessary thickness of the protective layer is difficult to realize for the various special applications of HID lamps, especially UHP lamps, for example due to the high manufacturing costs in terms of industrial mass production. Another disadvantage of this solution is also that the outer layer of the interference filter must always be the protective layer, so that the design options for the interference filter are necessarily limited.

The object of the present invention is, therefore, to develop a lamp of the type described in the opening paragraph or an illumination unit with said lamp, whose lamp bulb has an interference filter with a protective layer that can be effectively produced in industrial mass production and whose thickness can be adapted to the required operating temperatures.

The object of the invention is achieved by the characteristics in claim 1.

The lamp of the invention comprises a lamp bulb, on the surface of which an interference filter is at least partially located, wherein at least said interference filter comprises several layers, wherein the layer structure comprises alternating layers with a higher refractive index and layers with a lower refractive index, wherein at least the outer layer and/or at least one inner layer of the interference filter comprises a protective layer to reduce thermal and/or intrinsic stresses, and wherein the thickness of the protective layer or protective layers has a value below 40% of the value of all other layers with the lower refractive index.

The present inventive solution is based on the experience gained from numerous tests with UHP lamps, i.e. tests with various designs regarding the interference filter. These results more particularly include the recognition that, in HID lamps, the selection of the coating materials, the design of the individual layers, and their arrangement in the layer structure are very significant for achieving the required spectral target function. In multi-layer interference filters with a relatively high layer thickness, i.e. a thickness of more than approximately. 3 μm, the location e.g. of at least one protective layer within the layer structure is essential.

The previously valid rule for the minimum thickness of the protective layer, as in U.S. Pat. No. 5,923,471, could surprisingly be significantly undershot This means that such multi-layer interference filters can for the first time be effectively industrially mass produced. The reduction in thickness of the protective layer results more particularly in savings in coating materials and shorter cycle times during interference filter production. In addition, this opens up new design possibilities and application areas for HID lamps with such interference filters.

The pre-selection of interference filter materials and the method of applying the respective filter layers occur in the normal manner and are based in particular on the respective applications. The selected material should for instance result in the lowest possible absorption. In addition, these materials must have a sufficient temperature resistance, i.e. must be particularly suited to the respective maximum operating temperature of the lamp.

The sub-claims relate to further advantageous embodiments of the present invention.

It is preferred that the materials of the protective layer, of the layer with the lowest refractive index, and of the lamp bulb are substantially comparable.

The material in question comprises more particularly SiO₂.

The preferred embodiment according to claim 3 requires that the layer of the interference filter with the lower refractive index preferably comprises SiO₂ and that the second layer of the interference filter comprises a material which has a higher refractive index than SiO₂, preferably mainly zirconium oxide (ZrO₂).

The preferred embodiment in claim 4 requires that the second layer comprises a material from the group of titanium oxide, tantalum oxide, niobium oxide, hafnium oxide, silicon nitride, particularly preferably zirconium oxide ZrO₂, or a mixture of these materials. ZrO₂ is particularly preferred as it absorbs less and is more temperature-resistant than most other materials.

In addition to the materials mentioned above and their mixtures, further materials may be used within the scope of the invention, and these may be, for example, checked for applicability by suitable tests.

Preferred methods of manufacturing interference filters are the known standard methods of thin-film technology, especially using vaporization, sputtering, chemical gas-phase deposition, or dipping.

The preferred lamp is a high intensity discharge lamp or a halogen lamp.

It is also preferred that the protective layer or all protective layers is or are located within the interference filter. In this case, there is no external protective layer present in this respect.

It is preferred with regard to further optimization of the design for a required spectral target function that several protective layers are located within the interference filter.

The object of the present invention is also achieved by an illumination unit with at least one lamp according to any one of the claims 1 to 6.

Such an illumination unit with at least one HID lamp may be more particularly used for projection purposes.

These and other aspects of the invention are apparent from and will be elucidated with reference to the embodiments described hereinafter.

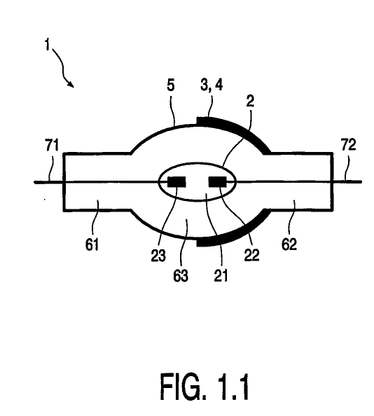

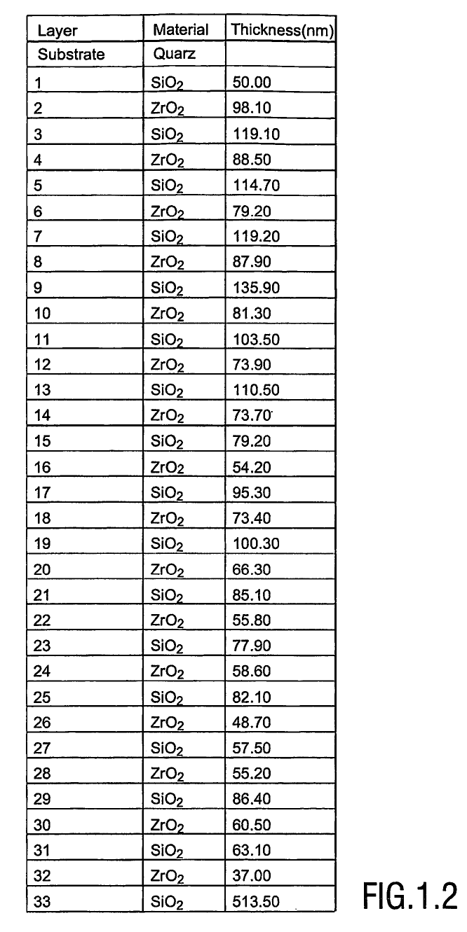

FIG. 1 shows the schematic sectional representation of a lamp bulb in a high intensity discharge lamp (UHP lamp) bearing a 33-layer interference filter,

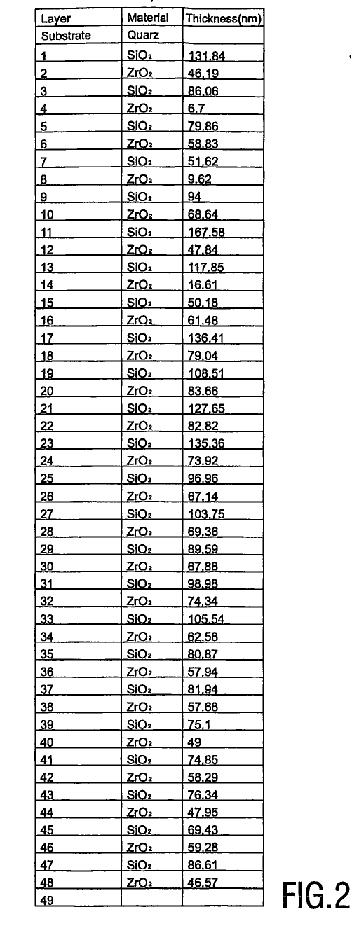

FIG. 2 shows the layer structure of a 48-layer interference filter without protective filter (state of the art),

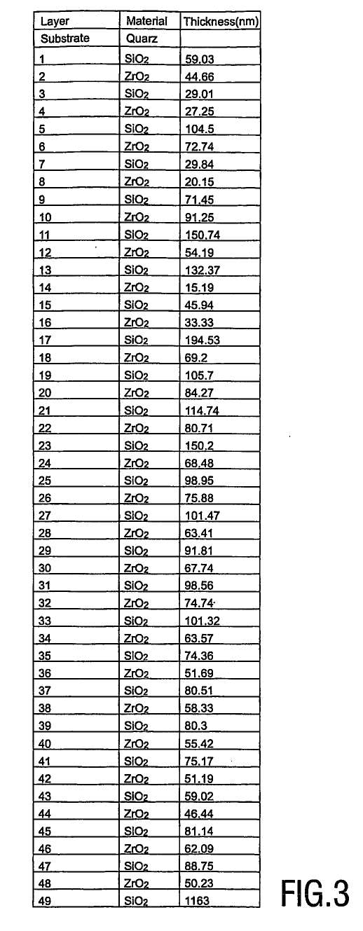

FIG. 3 shows the layer structure of a 49-layer interference filter with protective filter (state of the art), and

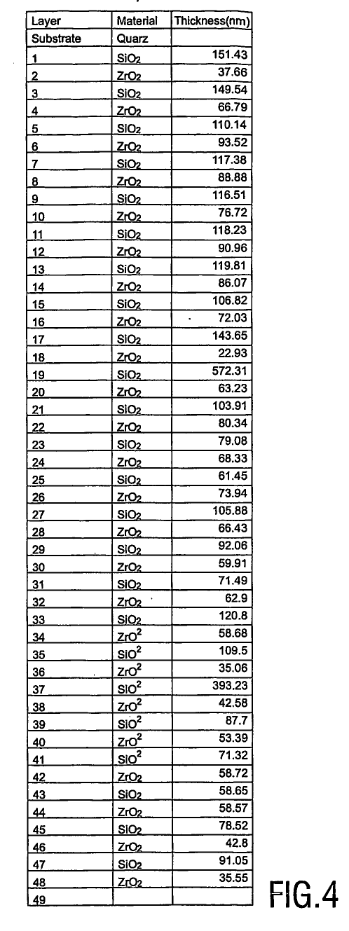

FIG. 4 shows the layer structure of a 48-layer interference filter with internal protective layers.

FIG. 1 schematically shows in sectional representation (FIG. 1.1) a lamp bulb 1 with a discharge space 21 of a high intensity discharge lamp (UHP lamp) according to the invention. The lamp bulb 1, consisting of one piece, which hermetically seals the discharge space 21 filled with the usual gas for this purpose, and whose material normally comprises hard glass or quartz glass, comprises two mutually opposed cylindrical areas 61, 62 between which a generally spherical area 63 with a diameter ranging from circa 8 m to 14 mm is located. The elliptically formed discharge space 21, with an electrode arrangement 2, is centrally located in the area 63. The electrode arrangement 2 generally comprises a first electrode 22 and a second electrode 23, between whose opposing tips a luminous arc discharge is excited in the discharge space 21, which luminous arc serves as the light source of the high intensity discharge lamp. The ends of the electrodes 22, 23 are connected to electrical connections 71,72 of the lamp, through which the supply voltage required to operate the lamp is delivered via a power supply unit not shown in FIG. 1.1 set up for a general line voltage.

An interference filter 3 and the light emission aperture 5 are located on the external surface of the area 63. The interference filter 3 is, in total, circa 3 μm thick and comprises several layers, functioning as a so-called cool light reflector. The external layer of the interference filter 3, which comprises SiO₂ in particular, is a protective layer 4 for reducing thermal and intrinsic stresses. The design of the interference filter 3, including the protective layer 4, and its structure are shown in FIG. 1.2. The interference filter 3 has a 33-layer structure, wherein the total layer thickness of the SiO₂ layers is 1993.3 nm and the total layer thickness of the ZrO₂ layers is 1092.3 nm. The thickness of the protective layer 4, which forms the external layer of the interference filter 3 exposed to the air, is 513.5 nm.

The two different layers 3.1 and 3.2 in the interference filter 3 are characterized in particular by a difference in refractive index, a layer with a lower index alternating with a higher-index layer. SiO₂ serves as the material with the lower refractive index for the layer 3.2; ZrO₂ serves as the material with the higher index for layer 3.1. The value of the protective layer 4 therefore amounts to ca. 35% of the value of the total thickness of other layers consisting of SiO₂, i.e. the layers 3.2.

The layered application of the interference filter 3 and the protective layer 4 is implemented in a manufacturing process based on the known sputtering method

No significant effects in excess of the normal ageing of comparable lamps could be observed on a UHP lamp with the described lamp bulb 1, operated at a nominal power of 120 W even after several thousand operating hours in the critical/high load range.

A particularly advantageous embodiment of the invention relates to a high intensity discharge lamp that is designed as a short-arc lamp and is used for projection purposes.

The embodiment of FIG. 2 shows in tabular form the layer structure of a 48-layer interference filter without protective layer. This design for an interference filter would normally be selected if the following spectral target function is required, i.e. a reflection above 95% in the range from 400 nm to 780 nm and a reflection below 20% in the range from 825 nm to 2000 nm. This interference filter has a 48-layer structure, wherein the total layer thickness of the SiO₂ layers is 2327 nm and the total layer thickness of the ZrO₂ layers is 1353 nm. The total thickness of the filter is therefore 3680 nm. This interference filter, however, does not posses the required temperature resistance in the range of operating temperatures between room temperature and a temperature of ca. 1000° C.

The embodiment of FIG. 3 shows in tabular form the layer structure of a 49-layer interference filter with an external protective layer according to U.S. Pat. No. 5,923,471. This interference filter has 49 layers, wherein the total layer thickness of the SiO₂ layers is 3382 nm, which value includes the thickness of the external protective layer of 1163 nm. The total layer thickness of the ZrO₂ layers is 1382 nm. The total thickness of the filter is 4764 nm, taking into account the thickness of the protective layer. The value of the protective layer is therefore ca. 52% of the value of the total thickness of all other SiO₂ layers.

The embodiment of FIG. 4 shows in tabular form the layer structure of a 48-layer interference filter 3 according to the invention with two inner protective layers (layer 19 and layer 37). This interference filter 3 has a 48-layer structure, wherein the total layer thickness of the SiO₂ layers is 3230 nm and the total layer thickness of the ZrO₂ layers is 1496 nm. The total thickness of the interference filter is therefore 4726 nm. The thickness of the two layers (layer 19 and layer 37) is in total 965 mm these being 572 nm (layer 19) and 393 nm (layer 37) thick, respectively. A protective layer 4 comprising SiO₂ is integrated into layer 19 and layer 37. Assuming that, when the protective layers 4 are discarded, the interference filters as shown in FIG. 2 and FIG. 4 approximately correspond to each other as regards the thickness of the respective layers, more particularly of the 19th layer and the 37th layer, thus a value for the thickness of the two protective layers 4 is obtained that can be determined by computer. The two protective layers 4 are therefore ca. 775 nm thick. The value of the two integrated protective layers 4 is therefore ca. 32% of the value of the total thickness of all other SiO₂ layers.

1. A lamp comprising a lamp bulb (1), on the surface of which at least one interference filter (3) is at least partially located, wherein at least this interference filter (3) comprises several layers, wherein the layer structure comprises alternating layers (3.1) with a higher refractive index and layers (3.2) with a lower refractive index, wherein at least the outer layer and/or at least one inner layer of the interference filter (3) comprises a protective layer (4) to reduce thermal and/or intrinsic stresses, and wherein the thickness of the protective layer (4) or protective layers (4) has a value below 40% of the value of all other layers with the lower refractive index.

2. Lamp as claimed in claim 1, characterized in that the materials used in the protective layer (4), the layer (3.2.), and the lamp bulb (1) are substantially comparable.

3. Lamp as claimed in claim 1, characterized in that the layer (3.2) of the interference filter (3) with the lower refractive index preferably comprises mainly SiO₂ and that the second layer (3.1) of the interference filter (3) comprises a material which has a higher refractive index than SiO₂, preferably mainly zirconium oxide (ZrO₂).

4. Lamp as claimed in claim 3, characterized in that the second layer (3.1) comprises a material from the group of titanium oxide, tantalum oxide, niobium oxide, hafnium oxide, silicon nitride, and particularly preferably zirconium oxide ZrO₂, or a mixture of these materials.

5. Lamp as claimed in claim 1, characterized in that the preferred lamp is a high intensity discharge lamp or a halogen lamp.

6. Lamp as claimed in claim 1, characterized in that the one protective layer (4) or all protective layers (4) is or are arranged within the interference filter (3).

7. Illumination unit with at least one lamp as claimed in claim 1.
